(19) United States
(12) Patent Application Publication
(10) Pub. No.: US 2025/0191069 A1
(43) Pub. Date: Jun. 12, 2025

(54) DEVICE FOR GUIDING THE EVALUATION OF INVESTMENT ITEMS AND METHOD OF OPERATING THE SAME

(71) Applicant: NeuroFusion Inc., Yongin-si (KR)

(72) Inventors: Han Chul Choi, Yongin-si (KR); Dong Yup LEE, Yongin-si (KR)

(73) Assignee: NeuroFusion Inc., Yongin-si (KR)

(21) Appl. No.: 18/918,162

(22) Filed: Oct. 17, 2024

(30) Foreign Application Priority Data
Dec. 11, 2023 (KR) 10-2023-0179060

(51) Int. Cl. G06Q 40/06

(52) U.S. Cl. CPC G06Q 40/06

(57) ABSTRACT

A method of operating a device for guiding evaluation of investment items includes setting questions for evaluating the investment items, providing a user interface displaying the questions and supplementary materials necessary for responding to the questions to a user device, the supplementary materials including financial statements, receiving responses to each of the questions of a first investment item from the user device, calculating an evaluation score of a user based on the responses to each of the questions, calculating a collective intelligence evaluation score based on responses of a plurality of investors to each of the questions, and providing a user interface displaying the evaluation score of the user and the collective intelligence evaluation score to the user device.

### CROSS-REFERENCE TO RELATED APPLICATIONS

This application claims the priority of Korean Patent Application No. 10-2023-0179060 filed on Dec. 11, 2023, in the Korean Intellectual Property Office, the disclosure of which is incorporated herein by reference.

### BACKGROUND

### Field

The present disclosure relates to a device for guiding evaluation of investment items and a method of operating the same.

### Description of the Related Art

In the stock market, numerous stocks are being traded. In addition, numerous cryptocurrencies are traded in the cryptocurrency market.

Investment analysis techniques that may be used in the stock market may be broadly divided into two types. There may be a fundamental analysis method of evaluating an intrinsic value of a company for investment and a technical analysis method of studying only price fluctuations of stock itself.

The fundamental analysis method is a method of calculating an intrinsic value of a company to be invested when investing in a particular stock, comparing the calculated intrinsic value with a current market price, and predicting the future price movement of the stock.

With the development of computer technology, new methods, such as system trading which is a method of automatically performing mechanical buying and selling for investment, have emerged.

The technology that forms the background of the disclosure has been written to facilitate a better understanding of the present disclosure. It should not be understood that the matters described in the technology that forms the background of the disclosure exist as the related art.

### SUMMARY

Due to the development of information and communication, investors may easily collect information they want and process the collected information to generate another form of information, so numerous pieces of information react to each piece of information, and all of the pieces of information may be reflected in the stock market, which is the most sensitive market to information.

There is a problem in that investors who invest with information continue to need more and more weighted analysis and invest only based on information they have obtained through experience.

Conversely, investors (e.g., individual investors) who invest without information may easily collect materials such as financial statements, but there is a problem that it is difficult to analyze which part of the financial statements to review or refer to, or what the meaning of the part is. Therefore, when investors decide on stocks they want to invest in, instead of a method of simply recommending investment items, a new method of guiding evaluation of investment items so that investors may analyze and evaluate various types of information related to the investment items and select the investment items on their own is required.

As a result, the inventors of the present disclosure attempted to develop a method of guiding evaluation of investment items by utilizing materials such as financial statements, materials on performance and outlook, and insider trading, and a device for performing the same.

Specifically, the inventors of the present disclosure attempted to develop a method of guiding evaluation of investment items by providing material(s) such as financial statements, material on performance and outlook, and insider trading, and at the same time, providing various questions related to the material(s), so that users may determine what information to review from the material(s) and ultimately how to evaluate the investment items while responding to the questions on their own, and a device for performing the same.

In addition, the inventors of the present disclosure attempted to develop a method of guiding a user to refer to a collective intelligence evaluation score when evaluating investment items by collecting responses from multiple users and providing statistical and analysis results, and a device for performing the same.

Aspects of the present disclosure are not limited to the above-mentioned aspects. That is, other aspects that are not mentioned may be obviously understood by those skilled in the art from the following specification.

In order to solve the above-described problem, a method of operating a device for guiding evaluation of investment items according to an embodiment of the present disclosure is provided. The method may include setting questions for evaluating the investment items, providing a user interface displaying the questions and supplementary materials necessary for responding to the questions to a user device, the supplementary materials including financial statements, receiving responses to each of the questions of a first investment item from the user device, calculating an evaluation score of a user based on the responses to each of the questions, calculating a collective intelligence evaluation score based on responses of a plurality investors to each of the questions, and providing a user interface displaying the evaluation score of the user and the collective intelligence evaluation score to the user device.

The questions may include at least one question for an income statement, at least one question for a balance sheet, or at least one question for a cash flow statement.

The supplementary materials may include a material on performance and outlook and a material on insider trading, the material on the performance and outlook may include indicators indicating performance and outlook including sales and earnings per share (EPS), and the material on the insider trading may include information on an insider name, a position, a report date, a transaction date, a transaction type, a transaction volume, an average price, a transaction amount, and features of the insider.

A score of the user may include an evaluation score of the first investment item, industry average score of the user, and an overall average score of the user, and the collective intelligence score may include a collective intelligence score of the first investment item, an industry average collective intelligence score, and an overall average collective intelligence score.

The method may further include outputting recommended investment items using an artificial intelligence model that uses the collective intelligence evaluation scores of the plurality of investment items as input, and providing the recommended investment items among the plurality of investment items to the user.

In order to solve the above-described problem, a device for guiding evaluation of investment items according to an embodiment of the present disclosure is provided. The device may include a memory, a transceiver configured to receive responses to each question of a first investment item from the user device, and a processor operably connected to the transceiver and the memory, in which processor may be configured to set questions for evaluating the investment items, provide a user interface displaying the questions and supplementary materials necessary for responding to the questions to a user device, the supplementary materials including financial statements, calculate an evaluation score of a user based on the responses to each of the questions, calculate a collective intelligence evaluation score based on responses of a plurality of investors to each of the questions, and provide a user interface displaying the evaluation score of the user and the collective intelligence evaluation score to the user device.

In order to solve the above-described problem, a method of operating a user device for evaluating investment items according to an embodiment of the present disclosure is provided. The method may include setting investment items and a type of questions according to a user input, receiving a response of the user to each question based on an income statement, a balance sheet, or a cash flow statement of the investment items, determining an option that the plurality of investors respond most frequently to each of the questions of the investment items based on the evaluation of the investment items submitted in advance by a plurality of investors, automatically responding to the question for which the response is not received from the user with the option that the plurality of investors respond to most frequently when the user selects an automatic response function, and generating the investment item evaluation result for the investment items.

The method may further include receiving the response of the user to each of the questions based on information on performance and outlook of the investment items or information on insider trading from the user, in which the information on the performance and outlook may include information on indicators indicating performance and outlook including sales and earnings per share (EPS), and the information on the insider trading may include information on an insider name, a position, a report date, a transaction date, a transaction type, a transaction volume, an average price, a transaction amount, or features of the insider.

In order to solve the above-described problem, a system for evaluating investment items according to an embodiment of the present disclosure is provided. The system may include a user device configured to receive responses to each evaluation question of the investment items from a user, and a investment item evaluation guide device comprising a processor configured to set the evaluation questions of the investment items, provide a user interface displaying the evaluation questions and evaluation supplementary materials to the user device, the supplementary materials including a financial statement, calculate an evaluation score of the user based on the responses of the user to each of the evaluation questions, and calculate a collective intelligence evaluation score based on the responses of a plurality of investors, in which the user device displays an investment item evaluation result including a statistical table of the evaluation score, the collective intelligence evaluation score, and the collective intelligence evaluation score.

Detailed contents of other exemplary embodiments are described in a detailed description and are illustrated in the drawings.

According to the present disclosure, investors can evaluate specific investment items based on evaluation questions using supplementary materials such as financial statements, which may help the investors select the investment items, and can select investment items with high evaluation scores to maximize their returns.

In addition, according to the present disclosure, investors can check other investors' thoughts or judgments about the prospects for specific investment items through the collective intelligence evaluation score, and consider the thoughts or judgments when selecting investment items.

In addition, according to the present disclosure, investors can receive recommendations for investment items based on financial statements, etc., by using an artificial intelligence model that uses the collective intelligence evaluation score as input.

The effects according to the present disclosure are not limited to the contents exemplified above, and further various effects are included in the present specification.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic diagram of a system for evaluating investment items according to an embodiment of the present disclosure;

FIG. 2 is a block diagram illustrating a configuration of a user device according to an embodiment of the present disclosure;

FIG. 3 is a block diagram illustrating a configuration of a device for guiding evaluation of investment items according to an embodiment of the present disclosure;

FIG. 4 is a flowchart of a method of operating a device for guiding evaluation of investment items according to an embodiment of the present disclosure;

FIG. 5 is a diagram illustrating a user interface displaying evaluation questions of investment items according to an embodiment of the present disclosure;

FIG. 6 is a diagram illustrating a user interface displaying a query of investment items according to an embodiment of the present disclosure;

FIG. 7 is a diagram illustrating a user interface displaying evaluation questions and supplementary materials of investment items according to an embodiment of the present disclosure;

FIG. 8 is a flow chart of a method of operating a user device for evaluating investment items according to an embodiment of the present disclosure;

FIG. 9 is a diagram illustrating a user interface displaying evaluation questions of investment items according to an embodiment of the present disclosure;

FIG. 10 is a diagram illustrating a user interface that displays an investment item evaluation result according to an embodiment of the present disclosure; and

FIGS. 11 and 12 are screens illustrating a user interface that is actually displayed on a user device according to an embodiment of the present disclosure.

### DETAILED DESCRIPTION OF THE EMBODIMENT

Advantages and features of the present disclosure and methods to achieve them will be elucidated from embodiments described below in detail with reference to the accompanying drawings. However, the present disclosure is not limited to embodiments disclosed below, and may be implemented in various different forms, these embodiments will be provided only in order to make the present disclosure complete and allow one of ordinary skill in the art to which the present disclosure pertains to completely recognize the scope of the present disclosure. Throughout the drawings, similar components will be denoted by similar reference numerals.

In the disclosure, an expression “have”, “may have”, “include”, “may include”, or the like, indicates existence of a corresponding feature (for example, a numerical value, a function, an operation, a component such as a part, or the like), and does not exclude existence of an additional feature.

In the present disclosure, an expression “A or B”, “at least one of A and/or B”, “one or more of A and/or B”, or the like, may include all possible combinations of items enumerated together. For example, “A or B”, “at least one of A and B”, or “at least one of A or B” may indicate all of 1) a case where at least one A is included, 2) a case where at least one B is included, or 3) a case where both of at least one A and at least one B are included.

Expressions “first,” “second,” “1st” or “2nd” or the like, used in the present disclosure may indicate various components regardless of a sequence and/or importance of the components, will be used only in order to distinguish one component from the other components, and do not limit the corresponding components. For example, a first user device and a second user device may indicate different user devices regardless of a sequence or importance thereof. For example, the ‘first’ component may be named the ‘second’ component and the ‘second’ component may also be similarly named the ‘first’ component, without departing from the scope of the present disclosure.

When it is mentioned that any component (for example, a first component) is (operatively or communicatively) coupled with/to or is connected to another component (for example, a second component), it is to be understood that any component is directly coupled to another component or may be coupled to another component through the other component (for example, a third component). On the other hand, when it is mentioned that any component (for example, a first component) is “directly coupled” or “directly connected” to another component (for example, a second component), it is to be understood that the other component (for example, a third component) is not present between any component and another component.

An expression “configured (or set) to” used herein may be replaced by an expression “suitable for”, “having the capacity to” “designed to”, “adapted to”, “made to”, or “capable of” depending on a situation. The term “˜configured (or set) to” may not necessarily mean “specifically designed to” in hardware. Instead, in some situations, an expression “apparatus configured to” may mean that the apparatus may “do” together with other apparatuses or components. For example, a “processor configured (or set) to perform A, B, and C” may mean a dedicated processor (for example, an embedded processor) for performing the corresponding operations or a generic-purpose processor (for example, a central processing unit (CPU) or an application processor) that may perform the corresponding operations by executing one or more software programs stored in a memory device.

Terms used in the present disclosure may be used only to describe specific embodiments rather than restricting the scope of other embodiments. Singular forms may include plural forms unless the context clearly indicates otherwise. All terms used herein including technical and scientific terms have the same meanings as those that are generally understood by those skilled in the art to which the present disclosure pertains. Terms defined by a general dictionary among terms used in the present disclosure may be interpreted as meaning that are the same as or similar to meanings within a context of the related art, and are not interpreted as ideal or excessively formal means unless clearly defined in the present disclosure. In some cases, terms may not be interpreted to exclude embodiments of the present disclosure even though they are defined in the present disclosure.

Each feature of various embodiments of the present disclosure may be partially or fully coupled or combined with each other, and as may be fully understood by those skilled in the art, various technical linkages and operations are possible, and each embodiment may be implemented independently of each other and may be performed together due to the related relationship.

For clarity in the interpretation of this specification, the terms used in this specification will be defined below.

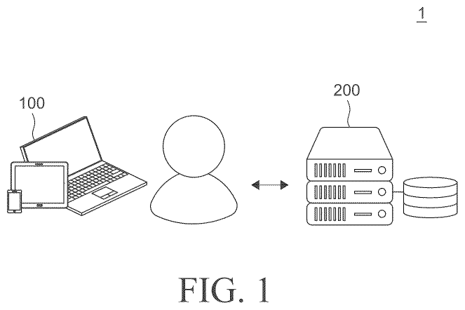

FIG. 1 is a schematic diagram of a system for evaluating investment items according to an embodiment of the present disclosure.

Referring to FIG. 1, an investment item evaluation system 1 includes a user device 100 and a user interface providing server 200 (hereinafter, a device 200 for guiding evaluation of investment items).

The device 200 for guiding evaluation of investment items of the investment item evaluation system 1 may set questions for evaluating investment items. The questions for evaluating investment items may be referred to as ‘evaluation questions’ below. The evaluation questions are a set of questionnaires and options that enable a user to evaluate the investment items. For example, the device 200 for guiding evaluation of investment items may provide 23 evaluation questions to a user for specific investment items (A. electronics) when the user selects specific investment items, in which the number of evaluation questions is variable. Hereinafter, the number of evaluation questions is described as 23 by way of example. Hereinafter, the device 200 for guiding evaluation of investment items may be abbreviated as ‘investment item evaluation guide device 200’.

The investment item evaluation guide device 200 may receive data for a plurality of investors. For example, the investment item evaluation system 1 may receive responses to each of the evaluation questions of specific investment items from the user device 100. In addition, the investment item evaluation system 1 may receive investment item evaluation results for a plurality of investors including the user. The investment item evaluation results may include an evaluation score of a user and a collective intelligence evaluation score. The user may maximize a return by selecting investment items to invest in based on the evaluation score of the user and the collective intelligence evaluation score.

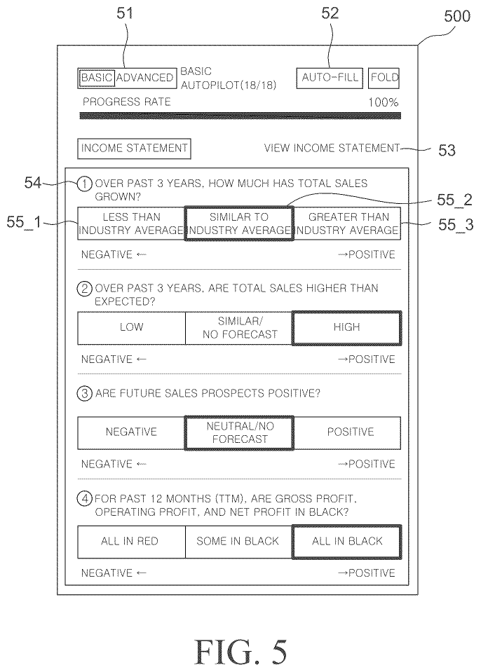

The investment item evaluation guide device 200 may provide the user device 100 with a user interface that displays questions for evaluating the investment items and supplementary materials necessary for responding to the questions. Examples of the user interface provided to the user device 100 are described below with reference to FIG. 5.

In this specification, the “investment items” may mean unique names of stocks, cryptocurrencies, etc., traded in a trading market of stocks, cryptocurrencies, etc. In addition, in this specification, a function of guiding evaluation of investment items by presenting the questions for evaluating the investment items to a user and guiding a calculation of evaluation scores may be called an ‘autopilot function’.

The device 200 for guiding evaluation of investment items of the investment item evaluation system 1 may calculate the evaluation score of the user based on responses to each of the evaluation questions of specific investment items received from the user device 100.

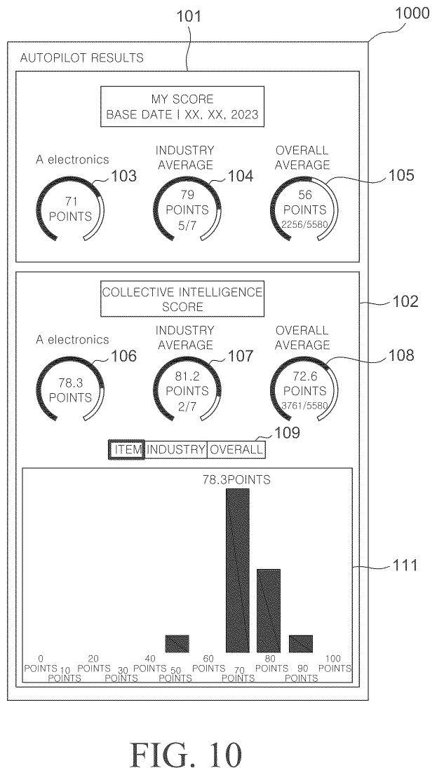

The device 200 for guiding evaluation of investment items may calculate the collective intelligence evaluation score based on the responses of the plurality of investors received from the user device 100. Specific details of the evaluation score and the collective intelligence evaluation score are described later with reference to FIG. 10. The device 200 for guiding evaluation of investment items may provide a user interface (i.e., an investment item evaluation guide interface) that displays the evaluation score and the collective intelligence evaluation score using the user device 100 carried by the user. Here, the user device 100 is an electronic device capable of capturing and/or outputting an image or video, and may include a smartphone, a tablet PC, a PC, a laptop, etc.

The user may respond to evaluation questions for specific investment items through the investment item evaluation system 1 and receive the investment item evaluation results including the evaluation score and the collective intelligence evaluation score calculated by the device 200 for guiding evaluation of investment items. Unlike the simple existing stock recommendation methods, the investment item evaluation system 1 provides the evaluation questions based on financial statements, etc., so that the user may actively evaluate the investment items, and provides the collective intelligence evaluation score evaluated by the plurality of investors as well as the user, thereby guiding the user to directly evaluate and select the investment items.

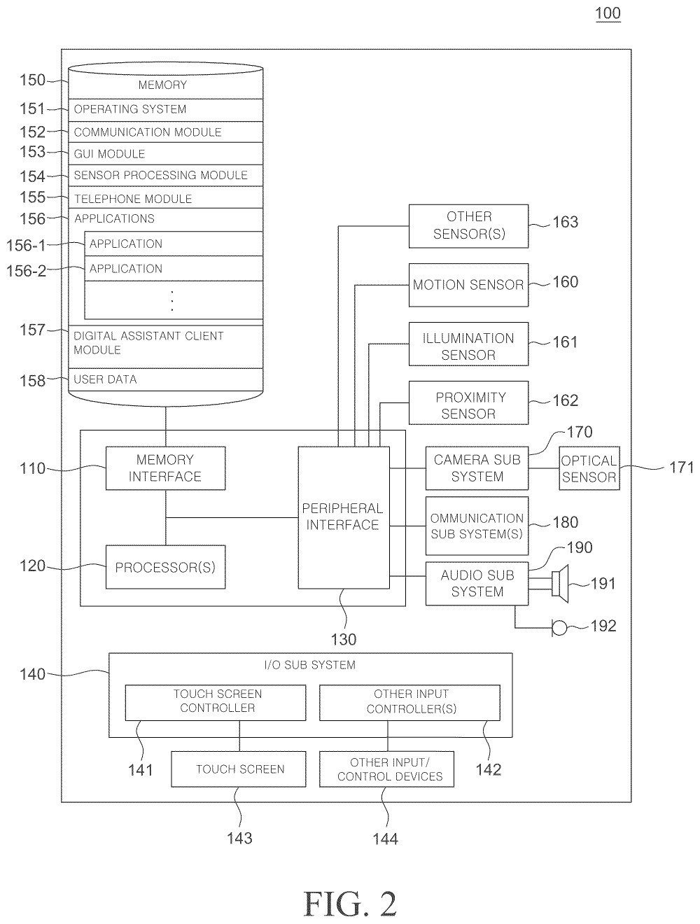

FIG. 2 is a block diagram illustrating a configuration of a user device according to an embodiment of the present disclosure.

Referring to FIG. 2, the user device 100 may include a memory interface 110, one or more processors 120, and a peripheral interface 130. Various components in the user device 100 may be connected by one or more communication buses or signal lines.

The memory interface 110 may be connected to a memory 150 to transmit various data to the processor 120. Here, the memory 150 may include at least one type of storage media such as flash memory type, hard disk type, multimedia card micro type, card type memory (for example, SD or XD memory), RAM, SRAM, ROM, EEPROM, PROM, network storage, cloud, and blockchain database.

In various embodiments, the memory 150 may store at least one of an operating system 151, a communication module 152, a graphical user interface (GUI) module 153, a sensor processing module 154, a telephone module 155, and an application 156. Specifically, the operating system 151 may include instructions for processing basic system services and instructions for performing hardware operations. The communication module 152 may communicate with at least one of other devices, computers, and servers. The graphical user interface (GUI) module 153 may process a graphical user interface. The sensor processing module 154 may process sensor-related functions (e.g., processing voice input received using one or more microphones 192). The telephone module 155 may process a telephone-related function. The application module 156 may perform various functions of a user application, such as electronic messaging, web browsing, media processing, navigation, imaging, and other processing functions. In addition, the user device 100 may store one or more software applications 156-1 and 156-2 associated with a type of service in the memory 150. The application 156-1 may perform various functions provided by the device 200 for guiding evaluation of investment items. The application 156-1 may be an investment item evaluation guide application. In this case, the application 156-1 may provide a user interface for displaying the investment item evaluation results including the evaluation score of the user for the investment items and the collective intelligence evaluation score to the user device 100.

In various embodiments, the memory 150 may store a digital assistant client module 157 (hereinafter, DA client module), and accordingly, may store instructions for performing client-side functions of the digital assistant, various user data 258 (e.g., responses to each question for evaluating the investment items, a total score of a user for specific investment items, an industry average score of a user, an overall average score of a user), data required for learning or inference of an artificial intelligence model, etc.

Meanwhile, the DA client module 157 may acquire voice input, text input, touch input, and/or gesture input of a user through various user interfaces (e.g., I/O subsystem 150) provided in the user device 100.

In addition, the DA client module 157 may output data in an audiovisual or tactile form. For example, the DA client module 157 may output data composed of a combination of at least two of the following: voice, sound, notification, text message, menu, graphic, video, animation, and vibration. In addition, the DA client module 157 may communicate with a digital assistant server (not illustrated) using the communication subsystem 180.

In various embodiments, the DA client module 157 may collect additional information on the surrounding environment of the user device 100 from various sensors, subsystems, and peripheral devices to construct a context associated with the user input. For example, the DA client module 157 may provide context information along with the user input to a digital assistant server to infer the user's intention. Here, the context information that may accompany the user input may include sensor information, such as lighting, ambient noise, ambient temperature, and images of the surrounding environment, videos. As another example, the context information may include physical states (e.g., device orientation, device position, device temperature, power level, speed, acceleration, motion pattern, cellular signal strength, etc.) of the user device 100. As another example, the context information may include information (e.g., processes running on the user device 100, installed programs, past and present network activity, background services, error logs, resource usage, etc.) related to a software status of the user device 100.

In various embodiments, the memory 150 may include additional or deleted instructions, and furthermore, the user device 100 may include additional components or exclude some components in addition to the components illustrated in FIG. 2.

The processor 120 may control the overall operation of the user device 100, and may perform various commands to implement the investment item evaluation guide interface by running applications or programs stored in the memory 150.

The processor 120 may correspond to a computational device such as a central processing unit (CPU) or an application processor (AP). In addition, the processor 120 may be implemented in the form of an integrated chip (IC) such as a system on chip (SoC) in which various computational devices are integrated.

The peripheral interface 130 may be connected to various sensors, subsystems, and peripheral devices to provide data so that the user device 100 may perform various functions. Here, performing any function by the user device 100 may be understood as being performed by the processor 120.

The peripheral interface 130 may receive data from a motion sensor 160, an illumination sensor (illumination sensor) 161, and a proximity sensor 162, so the user device 100 may perform orientation, light, proximity detection functions, etc. As another example, the peripheral interface 130 may receive data from other sensors 163 (positioning system—GPS receiver, temperature sensor, and biometric sensor), so the user device 100 may perform functions related to the other sensors 163.

In various embodiments, the user device 100 may include a camera subsystem 170 connected to the peripheral interface 130 and an optical sensor 171 connected thereto, so the user device 100 may perform various capturing functions, such as taking pictures and recording video clips.

In various embodiments, the user device 100 may include a communication subsystem 180 connected to the peripheral interface 130. The communication subsystem 180 may include one or more wired or wireless networks and may include various communication ports, radio frequency transceivers, and optical transceivers.

In various embodiments, the user device 100 may include an audio subsystem 190 connected to the peripheral interface 130, and the audio subsystem 190 may include one or more speakers 191 and one or more microphones 192, so that the user device 100 may perform voice-activated functions, such as voice recognition, voice duplication, digital recording, and telephone functions.

In various embodiments, the user device 100 may include the I/O subsystem 150 connected to the peripheral interface 130. For example, the I/O subsystem 150 may control a touch screen 143 included in the user device 100 via a touch screen controller 141. As an example, the touch screen controller 141 may detect the user's contact and movement or the stop of the user's contact and movement using any one of a plurality of touch sensing technologies, such as a capacitive type, a resistive type, an infrared type, a surface acoustic wave technology, and a proximity sensor array. As another example, the I/O subsystem 150 may control other input/control devices 144 included in the user device 100 via other input controller(s) 142. As an example, the other input controller(s) 142 may control one or more buttons, rocker switches, thumb-wheels, infrared ports, USB ports, and pointer devices, such as a stylus.

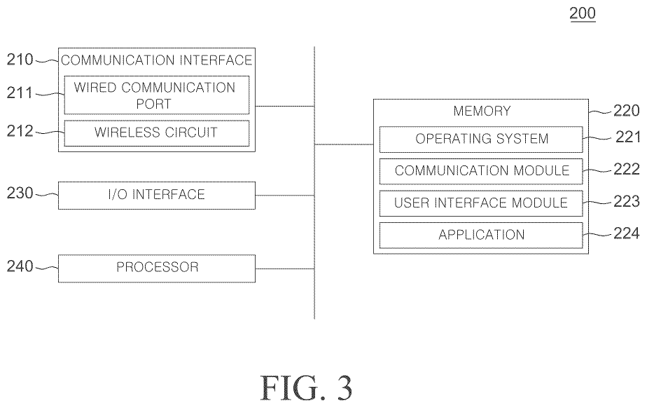

FIG. 3 is a block diagram illustrating a configuration of a device for guiding evaluation of investment items according to an embodiment of the present disclosure.

Referring to FIG. 3, the device 200 for guiding evaluation of investment items may include a communication interface 210, a memory 220, an I/O interface 230, and a processor 240, and each component may communicate with one another through one or more communication buses or signal lines.

The communication interface 210 may be connected to the user device 100 via a wired/wireless communication network to exchange data. For example, the communication interface 210 may receive data on types of investment items and questions from the user device 100. The communication interface 210 may receive the responses to each of the evaluation questions of the investment items from the user device 100. The communication interface 210 may receive the responses of the user to each of the questions based on an income statement, a balance sheet, or a cash flow statement of the investment items from the user device 100. In addition, the communication interface 210 may receive the responses of the user to each of the questions based on information on performance and outlook of the investment items, or information on insider trading from the user device 100. The communication interface 210 may receive data related to an automatic response function from the user device 100. The communication interface 210 may receive data in advance from the user device 100, and the data may be stored in the memory 220. As another example, the communication interface 210 may receive data from the user device 100, if necessary, and update the data.

Meanwhile, the communication interface 210 may transmit the evaluation score of the user, the collective intelligence evaluation score, and/or the recommended investment items output by the artificial intelligence model to the user device 100.

Meanwhile, the communication interface 210 that enables the transmission and reception of such data includes a wired communication port 211 and a wireless circuit 212, and the wired communication port 211 may include one or more wired interfaces, for example, Ethernet, a universal serial bus (USB), FireWire, etc. In addition, the wireless circuit 212 may transmit and receive data with an external device via RF signals or optical signals. In addition, the wireless communication may use at least one of a plurality of communication standards, protocols, and technologies, such as GSM, EDGE, CDMA, TDMA, Bluetooth, Wi-Fi, VoIP, Wi-MAX, or any other suitable communication protocol.

The memory 220 may store various data used in the device 200 for guiding evaluation of investment items. For example, the memory 220 may store the investment items and question types selected by the user. The memory 220 may store the questions for evaluating the investment items. The memory 220 may store the responses to each question for evaluating the investment items, the total score of the user for specific investment items, the industry average score of the user, and/or the overall average score of the user.

The memory 220 may store data required for learning or inference of the artificial intelligence model. The artificial intelligence model according to an embodiment of the present disclosure may be an investment item recommendation model. The artificial intelligence model according to an embodiment of the present disclosure may be implemented as a machine learning-based algorithm. Alternatively, the artificial intelligence model according to an embodiment of the present disclosure may include a neural network. Here, the neural network may include a convolutional neural network (CNN), a recurrent neural network (RNN), a perceptron, a multilayer perceptron, feed forward (FF), a radial basis network (RBN), deep feed forward (DFF), long short term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and an attention network (AN), but is not limited thereto. Accordingly, it will be appreciated by those skilled in the art that the neural network may include any arbitrary neural network.

The investment item recommendation model according to an embodiment of the present disclosure may be trained through the investment item evaluation results written by a plurality of investors and generated by the device 200 for guiding evaluation of investment items. The trained investment item recommendation model may provide the recommended investment items among the plurality of investment items to the user.

In various embodiments, the memory 220 may include volatile or nonvolatile recording media capable of storing various data, commands, and information. For example, the memory 220 may include at least one type of storage media such as flash memory type, hard disk type, multimedia card micro type, card type memory (e.g., SD or XD memory, etc.), RAM, SRAM, ROM, EEPROM, PROM, network storage, cloud, and blockchain database.

In various embodiments, the memory 220 may store at least one of an operating system 221, a communication module 222, a user interface module 223, and one or more applications 224.

The operating system 221 (e.g., embedded operating system such as LINUX, UNIX, MAC OS, WINDOWS, and VxWorks) may include various software components and drivers for controlling and managing general system operations (e.g., memory management, storage device control, power management, etc.) and may support communication between various hardware, firmware, and software components.

The communication module 222 may support communication with other devices via the communication interface 210. The communication module 222 may include various software components for processing data received by the wired communication port 211 or the wireless circuit 212 of the communication interface 210.

The user interface module 223 may receive user request or input from a keyboard, a touch screen, a microphone, etc., via the I/O interface 230, and may provide a user interface on a display.

The application 224 may include a program or module configured to be executed by one or more processors 240. The application 224 may be an economic phenomenon prediction application. In an embodiment, the application 224 for providing an economic phenomenon prediction value may be implemented on a server farm.

The I/O interface 230 may connect at least one of input/output devices (not illustrated) of the device 200 for guiding evaluation of investment items, such as a display, a keyboard, a touch screen, and a microphone, to the user interface module 223. The I/O interface 230 may receive the user input (e.g., voice input, keyboard input, touch input, etc.) together with the user interface module 223, and process commands according to the received input.

The processor 240 may be connected to the communication interface 210, the memory 220, and the I/O interface 230 to control the overall operation of the device 200 for guiding evaluation of investment items, and perform various commands to evaluate the investment items through applications (e.g., investment item evaluation guide application) and/or programs (e.g., investment item evaluation guide program) stored in memory 220 and provide the recommended investment items.

The processor 240 may correspond to a computational device such as a central processing unit (CPU) or an application processor (AP). In addition, the processor 240 may be implemented in the form of an integrated chip (IC) such as a system on chip (SoC) in which various computational devices are integrated. Alternatively, the processor 240 may include a module for calculating an artificial neural network model such as a neural processing unit (NPU).

In an embodiment, the processor 240 may set the questions for evaluating the investment items. For example, the processor 240 may set 23 evaluation questions to derive the investment item evaluation result. The processor 240 may set different questions for evaluation depending on the characteristics of the type, industrial field, etc., of the investment items. The evaluation question may include, for example, a question asking how much total sales have grown over the past three years, or a question asking whether sales over the past three years are higher than the forecast.

The processor 240 may provide a user interface displaying the questions and the supplementary materials necessary for responding to the questions to the user device.

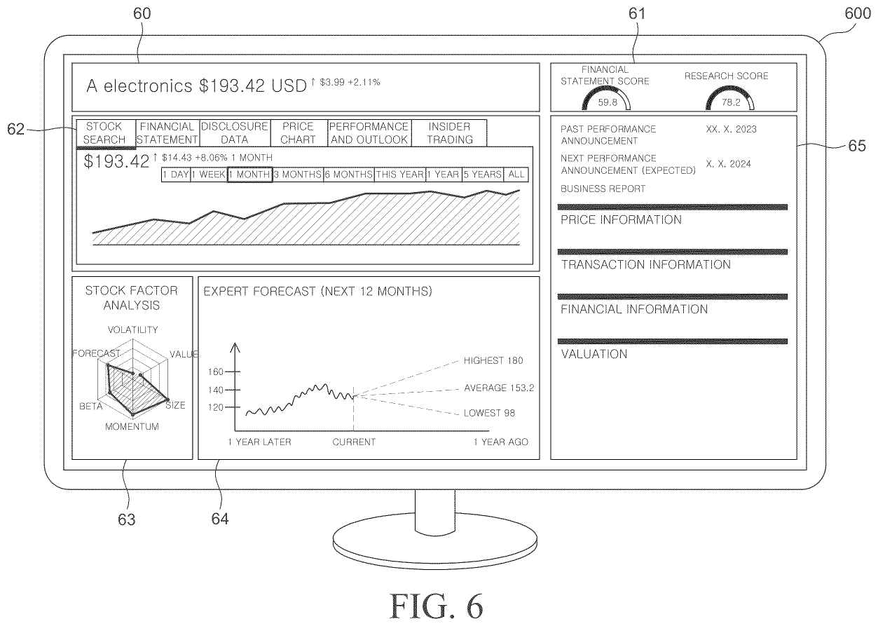

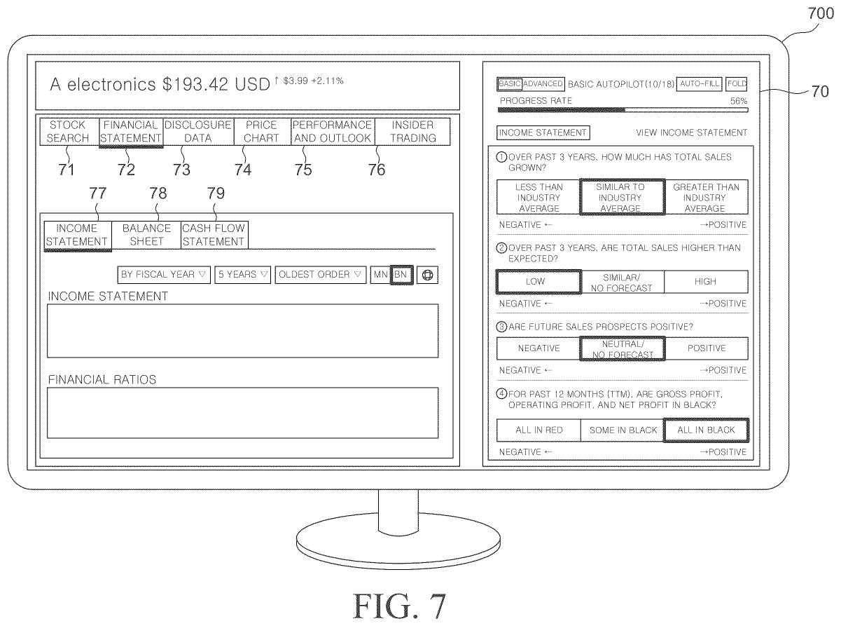

The supplementary materials necessary for responding to the questions may include materials for stock search, financial statements, disclosure materials, price charts, performance and outlook, and/or materials for insider trading. Specific details of the user interface displaying the material for the stock search together with the questions are described later with reference to FIG. 6, and specific details of the user interface displaying the financial statements together with the questions are described later with reference to FIG. 7.

In an embodiment, the processor 240 may receive responses to each of the questions for evaluating the specific investment items (hereinafter, referred to as the first investment item) from the user device 100. For example, the processor 240 may receive, from the user device 100, information on an option selected by a user for each of the 23 questions for evaluating a first investment item called A electronics. In addition, the processor 240 may receive, from the user device 100, responses of a plurality of investors to each of the questions for evaluating the first investment item.

The processor 240 may calculate an evaluation score of a user based on the responses to each of the questions. In addition, the processor may calculate a collective intelligence evaluation score based on the responses of the plurality of investors including the user to each of the questions.

The processor 240 may provide the user device 100 with the user interface displaying the evaluation score of the user for the first investment item and the collective intelligence evaluation score for the first investment item. The processor 240 may additionally provide a user interface to the user device 100, the user interface additionally displaying not only the first investment item, but also all investment items within the industry sector including the first investment item among the investment items for which the user has already submitted the investment item evaluation result, and/or an average score of all investment items for which the user has already submitted the investment item evaluation result. A detailed description thereof will be described later with reference to FIG. 10.

The configuration of the device 200 for guiding evaluation of investment items according to an embodiment of the present disclosure has been described so far. Hereinafter, a method of guiding evaluation of investment items through the device 200 for guiding evaluation of investment items described above will be described.

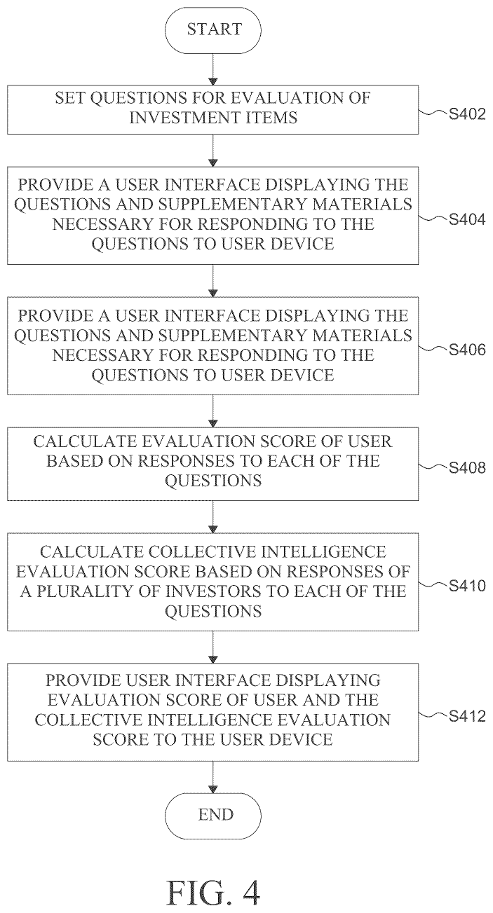

FIG. 4 is a flowchart of a method of operating a device for guiding evaluation of investment items according to an embodiment of the present disclosure.

Referring to FIG. 4, the device 200 for guiding evaluation of investment items (FIG. 1) according to an embodiment of the present disclosure sets questions for evaluating investment items (S402).

The questions for evaluating the investment items may include at least one question for an income statement, at least one question for a balance sheet, or at least one question for a cash flow statement.

The device 200 for guiding evaluation of investment items provides the user device with the user interface that displays the questions for evaluating the investment items and the supplementary materials necessary for responding to the questions (S404).

The supplementary materials may include the financial statements. In addition, the supplementary materials may include a material on performance and outlook and a material on insider trading. Here, the material on the performance and outlook may include indicators indicating performance and outlook including sales and earnings per share (EPS). The material on the insider trading may include information on an insider name, a position, a report date, a transaction date, a transaction type, a transaction volume, an average price, a transaction amount, and features of the insider.

The device 200 for guiding evaluation of investment items receives the responses to each of the questions of the first investment item from the user device (S406).

The first investment item (or specific investment items) refers to investment items input to the user device by the user's selection among the plurality of investment items and items for which the user wants to proceed with the investment item evaluation.

The device 200 for guiding evaluation of investment items calculates the evaluation score of the user based on the responses to each of the questions (S408).

The evaluation score of the user may include the total score of 1 investment item, the industry average score of the user, and the overall average score of the user.

The industry average score of the user refers to an average score of all investment items in an industry sector in which the first investment item is included among the investment items for which the user has already submitted the investment item evaluation results. The overall average score of the user refers to the average score of all the investment items for which the user has submitted the investment item evaluation results.

The device 200 for guiding evaluation of investment items calculates the collective intelligence evaluation score based on the responses of the plurality of investors to each of the questions (S410).

The device 200 for guiding evaluation of investment items provides the user device with the user interface that displays the evaluation score of the user and the collective intelligence evaluation score (S412).

In addition, the device 200 for guiding evaluation of investment items may output recommended investment items by using the artificial intelligence model that inputs the collective intelligence evaluation scores of the plurality of investment items. Accordingly, the device 200 for guiding evaluation of investment items may provide the user with recommended investment items among the plurality of investment items.

FIG. 5 is a diagram illustrating a user interface displaying evaluation questions of investment items according to an embodiment of the present disclosure.

Referring to FIG. 5, a user interface that displays some of the evaluation questions for specific investment items is illustrated.

The questions for evaluating the investment items may be divided into basic questions and advanced questions. The user may select the type of questions using a question type tab 51 on the screen (or user interface) 500 of the user device.

The basic question may be a question that may respond to by simply reading the supplementary material, or by a relatively simple calculation (e.g., calculating a ratio) using the contents included in the supplementary material. In contrast, in order to respond to the advanced question, a relatively complex calculation using the contents included in the supplementary material is required, or a one-time special event should be checked, or annotations in the supplementary material should be reviewed. In other words, the advanced question may require more review and effort from the user compared to the basic question in order to respond to the advanced question, and may be a question that may respond to by the relatively complex calculation using the contents included in the supplementary material. The user may proceed with the evaluation of the investment items by responding to only the basic question, or proceed with the evaluation of the investment items by responding to both the basic question and the advanced question.

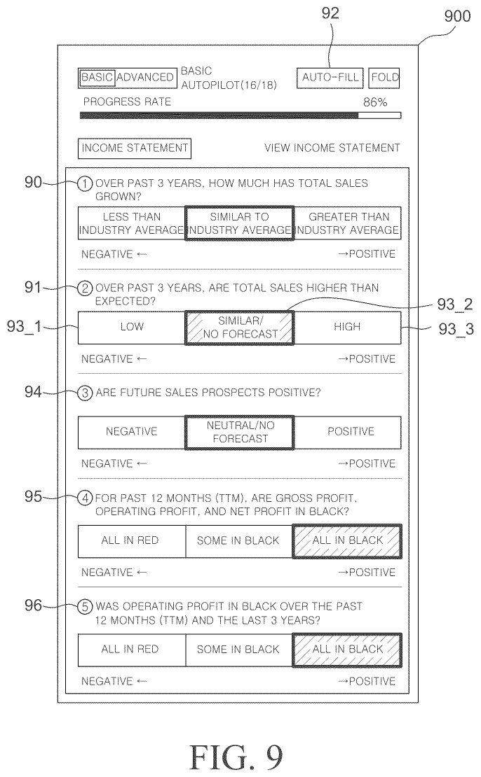

The user may automatically respond to all or part of the evaluation questions by using an auto-fill tab 52 on a screen (or user interface) 500 of the user device. A detailed description thereof will be described later with reference to FIG. 9.

The questions for evaluating the investment items may include at least one question for an income statement, at least one question for a balance sheet, or at least one question for a cash flow statement. The question for the income statement means a question that may respond to by checking the income statement among the supplementary materials, or a question related to the contents included in the income statement. The question for the balance sheet means a question that may respond to by checking the balance sheet among the supplementary material, or a question related to the contents included in the balance sheet. At least one question for the cash flow statement means a question that may respond to by checking the cash flow statement among the supplementary materials, or a question related to the contents included in the cash flow statement.

Referring to FIG. 5, a user interface displaying four questions for the income statement is illustrated.

The four questions for the income statement include question 1 54, question 2, question 3, and question 4. The question 1 is a question that asks how much total sales have grown over the past three years. The question 1 has three options, and the contents of each option correspond to ‘less than the industry average 55_1’, ‘similar to the industry average 55_2’, and ‘greater than the industry average 55_3’.

The question 2 is a question that asks whether total sales over the past three years were higher than the forecast. The question 2 has three options, and the contents of each option correspond to ‘low’, ‘similar/no forecast’, and ‘high’. The question 3 is a question that asks whether the future sales outlook is positive. The question 3 has three options, and the contents of each option correspond to ‘negative’, ‘neutral/no forecast’, and ‘positive’. The question 4 is a question that asks whether the gross profit, operating profit, and net profit over the past 12 months are in the black. The question 4 has three options, and the contents of each option correspond to ‘all in the red’, ‘only some in the black’, and ‘all in the black’.

In an embodiment, a user may check the total sales over the past 3 years of the income statement and then respond to the question 1 54 with the option corresponding to ‘similar to the industry average 55_2’.

FIG. 6 is a diagram illustrating a user interface displaying a query of investment items according to an embodiment of the present disclosure.

Referring to FIG. 6, a user interface is shown that displays an investment item search of ‘A electronics’ which is an investment item selected by a user according to an embodiment of the present disclosure.

A screen (or user interface) 600 of the user device may include a basic section 60 that shows basic contents of investment items, a score section 61 that shows evaluation scores related to the investment items, and a stock search tab 62 that provides information 65 such as a stock factor analysis 63, a expert forecast 64, a performance, a business report, and a price.

The basic section 60 may include contents about the name, price, and currency of the investment items, the amount of increase or decrease compared to the previous day, and the percentage of increase or decrease. For example, through the basic section 60, a user may confirm that the current stock price of A electronics, which is the investment items that the user wants to evaluate, is $193.42 in US dollars, increases by $3.99 compared to yesterday, and is a 2.11% increase.

The score section 61 may include a financial statement score and/or a research score. The financial statement score may be the total evaluation score of the investment items. For example, the financial statement score, i.e., the total evaluation score of the investment items, may be a score of 23 evaluation questions that the user responds to. The financial statement score, i.e. the total evaluation score of the investment items, may be 59.8 points.

When the user clicks the stock search tab 62 on the screen (or user interface) 600 of the user device, the information on the investment items may be searched.

In an embodiment, the information on the investment items may include the price fluctuation history of the A electronics which is the investment item that the user wants to evaluate. The information on the investment items may include stock factor analysis 63 analyzed using factors including forecast, volatility, value, beta, momentum, and size. The information on the investment items is obtained through multiple experts for the next 12 months, and may include expert forecast 64, which include a graph showing the lowest, average, and highest prices forecasted by multiple experts. In addition, the information on the investment items may include a business report and information on price information, transaction information, financial information, valuation, institutional holding ratio, and/or company overview. Here, the price information may include information on the previous day's closing price, previous day's increase/decrease, annual increase/decrease, and/or change rate over a certain period. The transaction information may include information on total issued shares, trading volume, average trading volume, volatility over a year, and/or dividend yield. The financial information may include information on market capitalization, total debt, cash holdings, and/or corporate value. The valuation may include valuation indicators such as price-to-earnings ratio.

FIG. 7 is a diagram illustrating a user interface displaying evaluation questions and supplementary materials of investment items according to an embodiment of the present disclosure.

Referring to FIG. 7, a user interface displaying a basic section showing basic contents of investment items of ‘A electronics’ which is an investment item selected by a user according to an embodiment of the present disclosure, an evaluation section 70 for evaluating ‘A electronics’, and a supplementary material section that is auxiliaryly necessary for responding to evaluation questions is illustrated.

A screen (or user interface) 700 of the user device may include the supplementary material section including tabs of various supplementary materials.

The tabs of various supplementary materials may include an item search tab 71, a financial statement tab 72, a public material tab 73, a price chart tab 74, a performance and outlook tab 75, and/or an insider trading tab 76. A user may use the tabs of various supplementary materials to respond to the evaluation questions of the evaluation section 70.

Referring to FIG. 7, when a user selects the financial statement tab 72, an income statement tab 77, a balance sheet tab 78, and a cash flow statement tab 79 that are sub-tabs may appear. In addition, when a user selects the income statement tab 77, a table showing the income statement and/or financial ratio may appear.

In an embodiment, when a user responds to questions for the income statement in the question 1 to question 4 in the evaluation section 70 located on the right side of the screen (or user interface) 700 of the user device, the user may click the financial statement tab 72 and the income statement tab 77 in the supplementary material section located on the left side of the screen (or user interface) 700 of the user device to utilize the supplementary materials, such as the income statement.

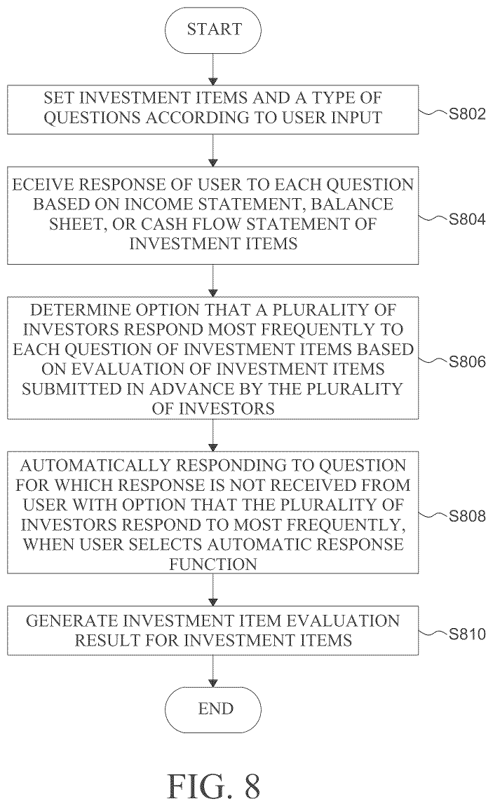

FIG. 8 is a flow chart of a method of operating a user device for evaluating investment items according to an embodiment of the present disclosure.

Referring to FIG. 8, the user device 100 according to the embodiment of the present disclosure sets investment items and a type of questions according to the user input (S802).

The user device 100 receives the response of the user to each question based on the income statement, the balance sheet, or the cash flow statement of the investment items (S804).

In another embodiment, the user device 100 may receive the responses of the user to each of the questions based on not only the income statement, the balance sheet, or the cash flow statement of the investment items, but also the information on the performance and outlook of the investment items or the information on insider trading from the user.

The information on the performance and outlook may include the information on indicators indicating performance and outlook including sales and earnings per share (EPS). The material on the insider trading may include information on an insider name, a position, a report date, a transaction date, a transaction type, a transaction volume, an average price, a transaction amount, and features of the insider.

The user device 100 determines an option that a plurality of investors respond most frequently to each question of investment items based on the evaluation of the investment items submitted in advance by the plurality of investors (S806).

In an embodiment, the user device 100 may determine that an option that the plurality of investors most frequently respond to the evaluation question (e.g., question 2) of the investment items is option 2.

Referring to FIG. 9, for question 2 91 (FIG. 9) asking whether the total sales of A electronics over the past three years are higher than the forecast, the option to which a plurality of investors respond most frequently is option 2 93_2 which corresponds to ‘similar/no forecast’.

Referring to FIG. 8,, the user device 100 automatically responds to a question for which response is not received from the user with the option that the plurality of investors respond to most frequently, when the user selects the automatic response function (S808).

Referring back to FIG. 9, the user may select an auto-fill tab 92. On a screen (or user interface) 900 of the user device, it is assumed that among a total of 23 evaluation questions, the questions that the user manually directly responds to using supplementary materials are question 1 90 and question 3 94, and the questions that the user does not directly respond to are the question 2 91, question 4 94, and question 5 96. In an embodiment, when the user clicks the auto-fill tab 92 after completing direct response to some of the 23 evaluation questions, the automatic response may be performed on the remaining question(s) excluding some of the questions that the user directly responds to, that is, for the question(s) to which no responses were received from the user, with the option to which a plurality of investors respond most frequently. For example, the user device may automatically respond to the question 2 91 with option 2 93_2 which corresponds to ‘similar/no forecast’ to which a plurality of investors most frequently respond. The user device may automatically respond to the question 4 95 with option 3 which corresponds to ‘all in the black’ to which a plurality of investors most frequently respond. In addition, the user device may automatically respond to the question 5 96 with option 3 which corresponds to ‘all in the black’ to which a plurality of investors most frequently respond.

Referring to FIG. 8, the user device 100 generates an investment item evaluation result for investment items (S810).

The investment item evaluation results may include an evaluation score of a user and a collective intelligence evaluation score.

Referring to FIG. 10, the autopilot result of ‘A electronics’, which is an investment item selected by the user according to an embodiment of the present disclosure, is illustrated.

A screen (or user interface) 1000 of the user device displays, as the investment item evaluation result, a my score section 101 which indicates the evaluation score of the user, and a collective intelligence score section 102 which indicates the collective intelligence evaluation score of a plurality of investors.

The my score section 101 may include an evaluation score graph 103 in which specific investment items, A electronics are calculated and displayed by the user responding to evaluation questions, an industry average graph 104 in which the average score of all investment items within an industry sector (e.g. electronics industry sector) that includes A electronics among the investment items for which the user has submitted the investment item evaluation results is calculated and displayed, and/or an overall average graph 105 in which the average score of all investment items for which the user has already submitted an investment item evaluation result is calculated and displayed.

The industry average graph 104 may include, for example, information (5/7) indicating that, when the number of investment items in an industry sector (e.g., electronics industry sector) including A electronics among the investment items for which the user has already submitted the investment item evaluation result is 7, the user has completed the investment item evaluation for 5 out of 7 items and a total of 5 investment item evaluation results have been generated. Similarly, the overall average graph 105 may include, for example, information (2256/5580) indicating that, when the number of investment items preset according to an embodiment of the present disclosure is 5580, the user has completed investment item evaluations for 2256 out of the 5580 investment items and a total of 2256 investment item evaluation results have been generated.

The collective intelligence score section 102 may include an evaluation score graph 103 in which an average score is calculated and displayed by a plurality of investors responding to evaluation questions for A electronics which is specific investment items, an industry average graph 107 in which an average score is calculated and displayed for investment items for which a plurality of investors have already submitted investment item evaluation results among all investment items in an industry sector (e.g., electronics industry sector) that includes A electronics, and/or an overall average graph 108 in which an average score is calculated and displayed for all investment items for which a plurality of investors have already submitted investment item evaluation results.

In addition, the collective intelligence score section 102 may include a graph 110 showing the score distribution for each of the evaluation score, the industry average score, and the overall average score. The screen (or user interface) 1000 of the user device may be provided with a selection tab 109 including an ‘item’ tab, an ‘Industry’ tab, and an ‘overall’ tab as tabs for checking the score distribution graphs for each of the evaluation score, the industry average score, and the overall average score.

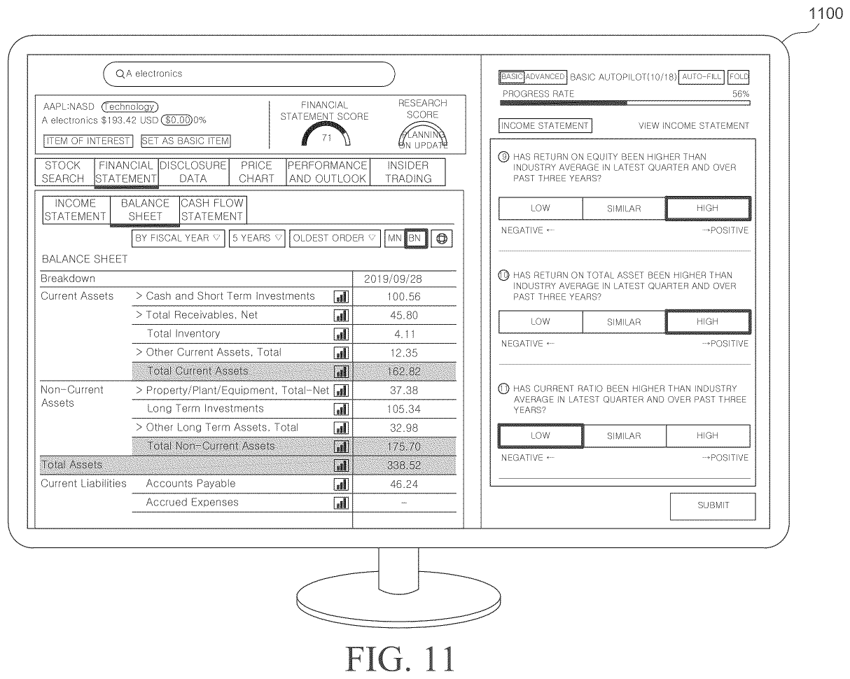

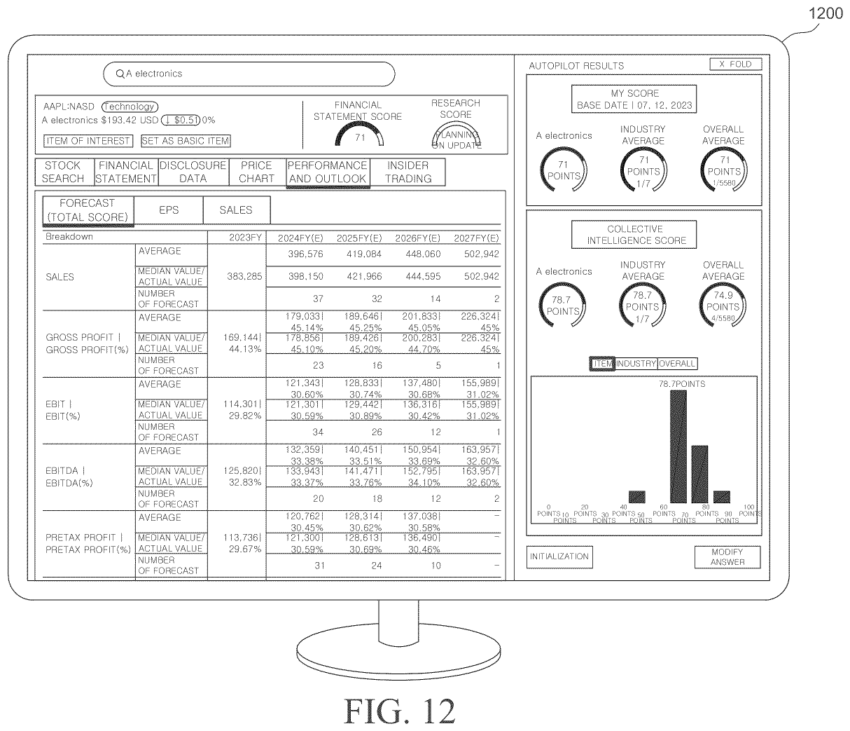

FIGS. 11 and 12 are screens illustrating a user interface that is actually displayed on a user device according to an embodiment of the present disclosure.

Referring to FIGS. 11 and 12, a user uses the basic autopilot function for investment items called Apple.

Referring to FIG. 11, in the screen (or user interface) 1100 of the user device, an evaluation section for evaluating investment items is displayed on the right side of the screen, and a supplementary material section that may be auxiliaryly used to respond to the evaluation questions is displayed on the left side of the screen.

In an embodiment, the user may use the balance sheet as the supplementary materials to respond to questions for the balance sheet. When the responses to all the evaluation questions are completed and submitted, the autopilot result is displayed as illustrated in FIG. 12.

Referring to FIG. 12, in the screen (or user interface) 1100 of the user device, an investment item evaluation result section indicating the information on the evaluation score of the user and the information on the collective intelligence evaluation score of a plurality of investors is displayed on the right side of the screen, and a supplementary material section that may be auxiliaryly used to respond to the evaluation questions is displayed on the left side of the screen.

In an embodiment, the user may check the autopilot result after completing responses to all the evaluation questions and submitting the responses. The user may evaluate the investment items by checking the collective intelligence evaluation score evaluated by not only the user but also a plurality of investors.

Although the embodiments of the present disclosure have been described in more detail with reference to the accompanying drawings, the present disclosure is not necessarily limited to these embodiments, but may be variously modified without departing from the scope and spirit of the present disclosure. Accordingly, embodiments disclosed in the present disclosure are not to limit the spirit of the present disclosure, but are to describe the spirit of the present disclosure. The scope of the present disclosure is not limited to these embodiments. Therefore, it should be understood that the above-mentioned embodiments are exemplary in all aspects but are not limited thereto. The scope of the present disclosure should be interpreted by the following claims, and it should be interpreted that all spirits equivalent to the following claims fall within the scope of the present disclosure.

What is claimed is:

1. A method of operating a device for guiding evaluation of investment items, the method comprising:
setting questions for evaluating the investment items;
providing a user interface displaying the questions and supplementary materials necessary for responding to the questions to a user device, the supplementary materials including financial statements;
receiving responses to each of the questions of a first investment item from the user device;
calculating an evaluation score of a user based on the responses to each of the questions;
calculating a collective intelligence evaluation score based on responses of a plurality of investors to each of the questions; and
providing a user interface displaying the evaluation score of the user and the collective intelligence evaluation score to the user device.

2. The method according to claim 1, wherein the questions include at least one question for an income statement, at least one question for a balance sheet, or at least one question for a cash flow statement.

3. The method according to claim 2, wherein the supplementary materials include a material on performance and outlook, and a material on insider trading,
the material on the performance and outlook includes indicators indicating performance and outlook including sales and earnings per share (EPS), and
the material on the insider trading includes information on an insider name, a position, a report date, a transaction date, a transaction type, a transaction volume, an average price, a transaction amount, and features of the insider.

4. The method according to claim 3, wherein a score of the user includes an evaluation score of the first investment item, industry average score of the user, and an overall average score of the user, and
the collective intelligence score includes a collective intelligence score of the first investment item, an industry average collective intelligence score, and an overall average collective intelligence score.

5. The method according to claim 4, further comprising:
outputting recommended investment items using an artificial intelligence model that uses the collective intelligence evaluation scores of the plurality of investment items as input; and
providing the recommended investment items among the plurality of investment items to the user.

6. A device for guiding evaluation of investment items, comprising:
a memory;
a transceiver configured to receive responses to each question of a first investment item from a user device; and
a processor operably connected to the transceiver and the memory,
wherein the processor is configured to set questions for evaluating the investment items, provide a user interface displaying the questions and supplementary materials necessary for responding to the questions to a user device, the supplementary materials including financial statements, calculate an evaluation score of a user based on the responses to each of the questions, calculate a collective intelligence evaluation score based on responses of a plurality of investors to each of the questions, and provide a user interface displaying the evaluation score of the user and the collective intelligence evaluation score to the user device.

7. The device according to claim 6, wherein the questions include at least one question for an income statement, at least one question for a balance sheet, or at least one question for a cash flow statement. 8 The device according to claim 7, wherein the supplementary materials include a material on performance and outlook and a material on insider trading,
the material on the performance and outlook includes indicators indicating performance and outlook including sales and earnings per share (EPS), and
the material on the insider trading includes information on an insider name, a position, a report date, a transaction date, a transaction type, a transaction volume, an average price, a transaction amount, and features of the insider.

9. The device according to claim 8, wherein the evaluation score includes an evaluation score of the first investment item, industry average score of the user, and an overall average score of the user, and
the collective intelligence evaluation score includes a collective intelligence score of the first investment item, an industry average collective intelligence score, and an overall average collective intelligence score.

10. The device according to claim 7, wherein the processor is further configured to output recommended investment items using an artificial intelligence model that uses the collective intelligence evaluation scores of the plurality of investment items as input, and provide the recommended investment items among the plurality of investment items to the user.

11. A method of operating a user device for evaluating investment items, comprising:
setting investment items and a type of questions according to a user input;
receiving a response of the user to each question based on an income statement, a balance sheet, or a cash flow statement of the investment items;
determining an option that a plurality of investors respond most frequently to each of the questions of the investment items based on the evaluation of the investment items submitted in advance by the plurality of investors;
automatically responding to the question for which the response is not received from the user with the option that the plurality of investors respond to most frequently, when the user selects an automatic response function; and
generating the investment item evaluation result for the investment items.

12. The method according to claim 11, further comprising:
receiving the response of the user to each of the questions based on information on performance and outlook of the investment items or information on insider trading from the user,
wherein the information on the performance and outlook includes information on indicators indicating performance and outlook including sales and earnings per share (EPS), and
the information on the insider trading includes information on an insider name, a position, a report date, a transaction date, a transaction type, a transaction volume, an average price, a transaction amount, or features of the insider.
